(19) United States
(12) Patent Application Publication
(10) Pub. No.: US 2012/0316995 A1
(43) Pub. Date: Dec. 13, 2012

(54) METHOD AND SYSTEM OF DISPLAYING, MANAGING AND SELLING IMAGES IN AN EVENT PHOTOGRAPHY ENVIRONMENT

(75) Inventors: BRYNLEY DAVIES, GRAND CAYMAN (KY); Jonathan Stark, Providence, RI (US)

(73) Assignee: IMAGE HOLDINGS

(21) Appl. No.: 13/554,333

(22) Filed: Jul. 20, 2012

Related U.S. Application Data
(63) Continuation-in-part of application No. 12/874,772, filed on Sep. 2, 2010.
(60) Provisional application No. 61/510,407, filed on Jul. 21, 2011.
(60) Provisional application No. 61/239,398, filed on Sep. 2, 2009.

(51) Int. Cl. G06Q 30/06

(52) U.S. Cl. 705/26.81

(57) ABSTRACT

A system and method for providing digital images to an event guest sometime after the event is provided where at least a portion of event photos are purchased before or during the event. Copy protected versions of the digital images are delivered to the guest who can copy and save a predetermined number of digital images based on their digital image purchase.

### CROSS-REFERENCE TO RELATED APPLICATIONS

This application claims the benefit of U.S. Provisional Patent Application Ser. No. 61/510,407, filed Jul. 21, 2011, titled “Methods for Displaying and Selling Photos in an Event Photography Workflow,” the entire disclosure of which is incorporated by reference herein.

This application is also a Continuation-In-Part of U.S. patent application Ser. No. 12/874,772, filed Sep. 2, 2010, which claims the benefit of U.S. Provisional Patent Application Ser. No. 61/239,398, filed Sep. 2, 2009, the entire disclosures of which are incorporated by reference herein.

This application is also related to U.S. patent application Ser. No. 12/883,947, filed Sep. 16, 2010, which claims the benefit of U.S. Provisional Patent Application Ser. No. 61/243,082, filed Sep. 16, 2009, the entire disclosures of which are incorporated by reference herein.

### FIELD OF THE INVENTION

Embodiments of the present invention are generally related to a system that facilitates guest purchase of event photos and/or videos (“images”).

### BACKGROUND OF THE INVENTION

Individuals attending an event or on a vacation often wish to obtain professional images of the event or special activities. As used herein, the term “event” may mean a single activity or multiple activities over the course of one or more days and the term “sub-event” means a single activity that is part of an event. For instance, a cruise is an event and embarking, disembarking, a formal dinner, and a dance related to the cruise are sub-events. An event may also refer to a charity event, a sporting event, a tour, a company event, a social event, a business event, a vacation event, or any other event where attendees may desire professional photographs. Amusement parks, theme parks, sports venues, and some resorts similarly provide photographers associated with specific rides or attractions or are located throughout the park or resort to take photographs of individuals, families, or groups of people. Event holders, such as a cruise lines, often display photographs taken at the event or at a sub-event in a centralized location with the hope that one or more attendees will review and purchase one or more of the photographs.

This method of operation—taking a photo, editing and printing the photo, displaying the photo in a gallery, and offering that photo for sale has been employed for a number of years. And one advantage of this traditional photo sales method is that finished products are placed in the hands of potential guests, which has been found to facilitate sales. One of skill in the art will appreciate that this method of selling photographs, however, is associated with an increased time and cost burden related to providing, editing and displaying photos that may never be purchased.

Photographs not purchased are discarded which is wasteful and environmentally unsound. Another disadvantage of the prior art method is that its effectiveness is a function of the size and length of the event. Simply put, the amount of photos associated with an event is directly proportional to the number of attendees and the length of the event. For example, very large cruise ships accommodate thousands of guests and extend for days and sometimes weeks. Thus the quantity of displayed photos increases dramatically. It follows that the time it takes for potential guests to find and review their photos will increase which translates to crowding. Increased crowds often lead to guest frustration and could lead to lost sales. To make matters worse, the event hosts will often condense and consolidate older photographs, which makes finding a particular photo difficult for those potential guests who may wait until near the end of the event to review photos for potential purchase.

Thus, some cruise lines, for example, have attempted to address the waste and congestion issue by providing one or more image viewing terminals that allow guests to review their images electronically. The stored digital images are accessible via a kiosk that allows a guest to make purchasing decisions to order digital photo products, hardcopy prints, and to order specialized image-related products like photo books. The kiosks in some instances allow the guest to purchase one or more digital images related to the event or sub-events that are saved onto a CD or other computer readable device or medium. The purchased photographs are then provided to the guest immediately or at a later time. As one skill in the art will appreciate, the digital images can be accessible on a kiosk (or other image viewing devices) located in a photographer's office, at a department store, etc.

One drawback of this system is that inevitably guests will choose to review their photographs and make purchasing decisions just before the end of the cruise or vacation. Adding to guest procrastination, is the fact that cruise or, to a lesser extent, event photos are taken throughout a guest's stay and, thus, guests cannot make a final purchasing decision until the end of the cruise or event as not all of the photos have been taken. Therefore, it is natural that the vast majority of sales, in some instances at least about 70%, occur at or near the end of the cruise or event. The surge in sales at the end of the cruise stresses the available staff and infrastructure. For example, some modern cruise ships accommodate at least 6,000 guests wherein many of which are vying for access to a limited number of photo kiosks to make purchasing decisions. When viewed on a per transaction basis, it becomes impractical to provide guests access to a limited number of kiosks for the purpose of reviewing and choosing which digital photos to purchase. To relieve this bottle neck, the number of kiosks could logically be increased, but doing so would be impractical as the size of each additional kiosk takes up valuable deck space and increases capital and operating costs.

One way to address this congestion issue has been to allow guests to purchase all images related to their stay. While this method eliminates selection time, reduces manpower responsibilities, and equipment needs, offering to sell all of the photos limits sales because the price charged for this type of package is often higher than some guests are willing to spend. Reducing the price for a complete photo package devalues the services and image-related items that could be sold.

An alternative sales method is to allow post-event sales by way of an internet photo sales portal. That is, guests or even attendees are given access to an internet-based virtual kiosk that is accessed at their convenience. The primary disadvantage with this approach is that event photograph sales are often an impulse purchase based around fresh memories of the event, and offering photos on-line after the event, i.e., cruise, defeats the objective of maximizing impulse sales. In addition, it is often impractical to transfer the very large number of digital photos taken at every event, which could reach many tens of thousands of images, over existing wired or wireless internet computer systems. Further, to maintain such information on a cloud network would increase cost, which is not desirable.

Thus, there is a long felt need to provide a system that allows guests or event attendees the ability to take the time they feel needed to make image purchasing decisions while allowing the event operator the ability to receive an immediate benefit of a sale.

### SUMMARY OF THE INVENTION

It is one aspect of the present invention to provide a photo delivery system that allows guests and potential guests to receive, interact, and purchase photos related to an event. One embodiment of the present invention is a computer software program, which may be accessed via the Internet, that employs a rich Internet application, such as Adobe® Flash, Adobe AIR, Java®, and other similar applications known to those in the art to simplify image design that enables enhanced image review and editing. In operation, images associated with an event are taken by a photographer or videographer employed by an event holder, and sold to an attendee/guest on a CD, DVD, Flash drive, thumb drive, via email, via the Internet, via a specialized intranet, or other similar media (hereinafter “electronic media”). The guest accesses the images by installing a computer application, either embedded in the electronic media received from the event holder or otherwise obtained by the guest, for example, via the Internet, an email, an intranet, or an application installed on a wireless communication device. The application allows the individual to access the purchased images in a native format, save a copy of the images, and manipulate the images as desired using a computer, including a desktop, laptop, notebook, smart phone, iPad®, Kindle®, Kindle Fire®, or similar wireless device. The application would also allow guests to order professional printing services, image enhancement or collateral items incorporating one or more of the images through a designated website hosted by the event holder or authorized third party. With respect to image enhancement, some embodiments contemplate facilitating interaction between the guest and event holder, or image expert employed thereby, wherein the guest may have the ability to request specific editing be performed on a particular image they have purchased. This interaction allows the image to be cropped, color enhanced, or altered using any other available techniques by a third-party professional, thereby relieving the event holder from the task of editing an image in a way that may not be acceptable or desired by the guest. As image editing and printing are no longer required of the event holder, time, costs, and waste are reduced.

It is another aspect of the present invention to provide an application that can be used in an online or offline mode. The online mode will allow users to connect to the Internet and increase functionality and features provided by the application that are associated solely with the website. Access may also be arranged through an intranet, such as a network available solely on a cruise ship, for example. Working online also allows the user to receive or access automatic upgrades to the application or at least be offered the opportunity to receive an upgrade. In the offline mode, core functions of the application would be available, such as the ability to manipulate and create new images and image products. Once the application is connected to the Internet or intranet, any edited photos and requests for image products may be synched to the event server for fulfillment. As used herein, “event server” means a database containing event images and interactive application software hosted by the event holder or an authorized third party. It is also contemplated that a guest's altered images may be synched or otherwise uploaded to an event server to be viewed by other interested parties or individuals, such as relatives, friends or acquaintances met at the event, who would have the ability to access and purchase the edited or unedited images. Similarly, the user may be able to upload to the server images taken by the user at the event.

In one embodiment of the present invention, a mobile application is provided for installation onto a mobile communication device such as an Android® phone, iPhone®, iPad®, Blackberry®, smart phone or personal digital assistant (PDA). The mobile application device will allow users to access the system prior to, during, or after an event in the same manner as accomplished on a home computer. As such, event specific details would be associated with the user's mobile device. In another embodiment of the present invention involving mobile or wireless devices, the user would then have the ability to notify the event organizer via the mobile device that a particular image or images were desired for purchase. An application resident on the mobile device or a web-based application accessed by the mobile device could transmit a signal to the event server that would contain data identifying the guest and the image. In instances that the application is loaded on the mobile device, sufficient information will have been gathered by the application or entered by the user identifying the user (name, mobile phone number), delivery details, and payment information. Features of the software application would also allow the individual to select or designate photos as they are being taken. For example, using the application, a signal is sent by the user's mobile device to a designated recipient. The signal includes a user identification and a time stamp or image specific identifying information, such as a location using global positioning technology. The camera equipment taking the images may be tied into the event server. As used herein, the term “event server” comprises the hardware and operational software that stores images and guest information, provides access to images, and permits copying and manipulation of images. The event server may be located at the event, such as on a cruise ship or at a particular resort or theme park, and following the event the images and other event-specific information may be transferred to a different event server located at a different location such as a centralized server hosting information from multiple events. In this way, the particular image will be located by matching the user and other identification information. The images may be sent to the user electronically for review and possible purchase. Alternatively, a user specific or image specific code may be sent to the server by the user's wireless device when prompted by the user. For example, sending a text message to a specific number associated with a specific photographer or videographer coupled with a time stamp would allow the event holder to forward the designated digital image directly to the user in real time or at a later time. Alternatively, an individual may pre-purchase rights to all photos of the event. Images of the individual's photos would be directly sent to their individual account, to their email or some other account associated with and accessible by the user. Further still, and as explained in more detail herein, the designated images may be printed and placed in a unique folder associated only with the purchaser and displayed or located in a designated display area.

It is thus one aspect of the present invention to provide a method of providing digital images to a guest comprising—taking a plurality of images of a guest at an event; forwarding digital versions of the images to the guest; providing a software application to the guest; allowing the software application to establish a connection to an event server that allows the guest to view the images and to purchase image related items; and allowing the user to copy and manipulate purchased images.

It is another aspect of the present invention to provide a method of providing digital images to an individual comprising: obtaining an image of the individual; receiving a signal indicating that the individual wishes to obtain the image; matching the individual with the image; and delivering the image to the individual. In one embodiment, the image or images may be printed and positioned in a physical folder uniquely associated with the purchaser. In this way, only desired images are printed. For marketing purposes, however, the event holder may create additional images or image-related products, not requested by the purchaser, and place them in the folder with the expectation the purchaser may also purchase one or more of these additional products. In another embodiment, the individual may be notified by a text message with instructions to access an image at a display carousel or by using an image viewing application. Alternatively, communication may be by an email message with instructions to access an image viewing application, an email message sent to guests who already have access to an appropriate image viewing application where the message is sent using the application or by using a conventional email account, a text message with a link to the image, an email message with a link to the image, a text message with a link to a website for accessing the image, an email message with a link to a website for accessing to the image, a phone call, a voice mail, a UPC code, or a QR code or by other notification methods known to persons of skill in the art.

The method and system of the present invention works with guests who have purchased rights to view, export and/or manipulate images before, during or following an event. For those guests who did not purchase rights prior to or during the event, or who did not purchase images or image-related products during the event, they can still access and acquire images after the event. In one embodiment, attendees of the event are provided images on electronic media, even if they have not purchased rights to the images. However, access to the images on the electronic media is restricted or blocked. The attendee can gain access to the blocked images by being provided an appropriate access code that is only provided to the attendee after the attendee purchases rights to the images. Alternatively, the attendee may access an authorized website, download the necessary software application, and provide contact and billing information in the same way as other guests did before and during the event. With the contact and billing information entered and saved to the event server, the attendee is given access to the images. As yet another alternative, the attendee may be given access to low resolution images or images with an obscuring watermark until the attendee purchases rights to the images in their native, or in some users edited, format.

It is another aspect of embodiments of the present invention to allow guests to purchase a predetermined number of digital images either before or during the event. Pre-event, e.g. cruise, sales are facilitated by a website that obtains guest details, product choice, and payment details. The contemplated website may be linked to or embedded in the event holder's website, i.e., cruise ship website. In the case of a cruise ship website, the photo package could be purchased similar to the many shore excursions are booked and paid for or gratuities are pre-paid. Guest information is passed to the ship so that the order can be fulfilled during the cruise, at guest departure, or at a later date. The photo package choices could be the same pre-cruise as what will be offered onboard, and a guest who has purchased a pre-cruise package may have the ability to amend their prior purchase during the cruise or thereafter. In one contemplated sales model, the pre-cruise package is less expensive than one purchased on or after the cruise.

For guests who do not choose to purchase pre-cruise photographs, digital images can be previewed and purchased through one of the onboard photo kiosks or gallery tablets that offer different size packages (e.g., 5 photos, 10 photos, 25 photos, 50 photos, or all photos). The contemplated gallery tablet may be an iPad© or similar device that is located at a centralized photo viewing location or delivered to the guest's room. As described in related U.S. patent application Ser. No. 12/883,947, for example, the user would use the tablet to view and order prints or digital images that are saved on a computer-readable medium. Still further, one of skill in the art will appreciate that the “tablet” could be any kind of personal digital assistant such as a smart phone or other similar device. Alternatively, the guest's digital images may be accessed and purchased through their room television.

As one of skill in the art will appreciate, photo packages may be offered on a basis other than a quantity or number of photos. An example would be event-type images (formal dinner(s), shore excursion(s), pool side, embarking, dis-embarking, etc.). A guest makes a package choice and payment at the kiosk or tablet. In one embodiment, payment is made by associating a charge with the guest's cruise card. It is also envisioned that families or other groups can link their guest-specific photos by linking cabin information pre-cruse, during the cruise, or after the cruise wherein anyone associated with the family or group can purchase a preselected package of linked photos that are not necessarily associated with one cabin or individual (i.e., photos of children with parents, grandparents, etc.).

Regardless if the purchase is pre-cruise or during the cruise, at the end of the cruise the guest is given a software application to access their photos at a website via the Internet. For example, the guest may be provided with a CD or thumb drive which, when accessed by a personal or home computer, installs an application that provides access to all of their photos that are locked, encrypted, or otherwise copyrighted. Alternatively, the guest may be given information, such as log-on identities or passwords, that grant guest access to their images through a website by way of their personal computer equipment. In one embodiment, thumbnail, reduced size, or watermarked versions of the images are provided for review. Alternatively, the software can provide information as to how the guest can access their photos that are stored on a cloud network or a link to an external network. The guest chooses which photos from a group consisting of all the photos associated with them to unlock and designate as part of the purchased package. The application then decrypts the selected high-resolution photos, which have been hidden from access until a selection has been made, or the selected photos are decrypted and forwarded to the guest via email, for example. The application uses an Internet connection and server to verify the package purchased, authorize the unlocking of the images, and to store any required data to ensure that a different set of photos are not unlocked from multiple instances of the installed application. The software application may also allow the guest to modify their previously selected package, for example by paying to expand their previously purchased package.

The application may also be used to make and sell other products that contain cruise images such as photo books, etc., as well as photographic prints. In one embodiment, the application allows guests to import their own photos for inclusion into these other products.

The contemplated application can also be used to provide a solution for communicating and addressing guest service issues as well as providing a solution for providing complimentary or incentivized images. It also provides a mechanism through which different related guests (friends or family) can share images and collaborate to make additional products like photo books.

It is yet another aspect of the present invention to provide a method for providing images to an event guest, comprising: obtaining an image order from the event guest before an event; obtaining a plurality of images of the event guest at the event; saving the plurality of images on a computer-readable medium; accessing the computer-readable medium after the event; selecting a subset of images from the plurality of images; and obtaining copies of the subset to fulfill at least a portion of the image order.

It is still yet another aspect of the present invention to provide a method for providing images to an event guest, comprising: obtaining an image order from the event guest before an event; obtaining a plurality of images of the event guest at the event; copy protecting the plurality of images; saving the copy protected images on a computer-readable medium; delivering the computer-readable medium to the event guest; providing an application program to the event guest; and communicating with the application program to selectively allow the event guests to obtain copies of at least one of the plurality of images.

The Summary of the Invention is neither intended nor should it be construed as being representative of the full extent and scope of the present invention. The embodiments described herein may be used in various combinations as described or independently. Moreover, references made herein to “the present invention” or aspects of the invention thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions. It should be understood, of course, that the invention is not necessarily limited to the particular embodiments illustrated herein.

FIG. 1 is a process flow of one embodiment of the present invention;

FIG. 2 is a process flow of another embodiment of the present invention;

FIG. 3 is a process flow of another embodiment of the present invention;

FIG. 4 is a process flow illustrating a pre-event/cruise purchase workflow of one embodiment of the present invention.

FIG. 5 is a process flow illustrating an event/cruise purchase workflow of one embodiment of the present invention;

FIG. 6 is a process flow illustrating a post event/cruise unlocking work flow of one embodiment of the present invention;

FIG. 7 is a process flow illustrating a post event/cruise unlocking work flow of one embodiment of the present invention;

FIG. 8 is a process flow illustrating a post event/cruise purchase workflow of one embodiment of the present invention;

FIG. 9 illustrates guest enhancements associated with one embodiment of the present invention;

FIG. 10 illustrates a method of providing complementary images of one embodiment of the present invention;

FIG. 11 illustrates another embodiment of the invention wherein digital images that are purchased during a cruise are allowed to be unlocked while onboard the cruise ship;

FIG. 12 illustrates an organizational structure associated with FIG. 11; and

FIG. 13 illustrates the photo sharing capabilities of one embodiment of embodiments of the invention.

### DETAILED DESCRIPTION

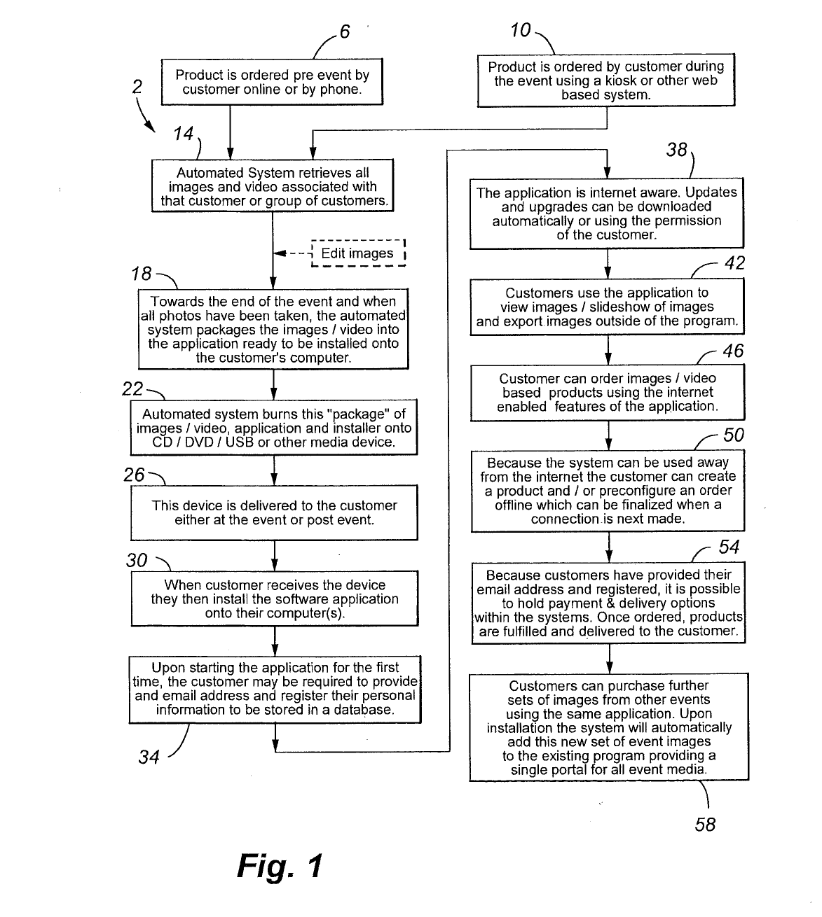

FIG. 1 shows a workflow associated with a digital image system 2 of one embodiment of the present invention. Here, images are ordered by the guest pre-event 6, either on-line, by phone, by mail or by other means. It is contemplated that the guest would be aware of the ability to pre-purchase images by word of mouth, product marketing or having previously experienced a particular event. For example, a cruise line often sells photo packages before the cruise begins. Alternatively, a kiosk, other web-based systems or paper order forms may be provided by the event operator that allows ordering by the guest during the event 10. The individual may also be notified of the ability to purchase event images via an email, social media websites, invitation websites, or other similar means.

A photographer and/or videographer captures and saves images at the event. At or near the end of the event, an automated system retrieves all images associated with a guest or group of guests 14. For example, it is well known in the art to use identification cards employing magnetic strips, bar codes and RFID technology to facilitate linking of individual to image. In addition, facial or pattern recognition, or other known methods may be used to index and group images. Methods of indexing and grouping images are described in U.S. Pat. Nos. 6,526,158, 6,819,783, and 7,561,723 and U.S. Patent Application Publication Nos. 2008/0310688 and 2012/0008837, the entire disclosures of which are incorporated by reference herein.

Towards the end of the event, all of the images are taken and uploaded into the digital photo system 2 for separation into a logical grouping. Such grouping may be guest specific, by cabin or room number, by an assigned or associated code, by individual identification, by family identification, etc. In one embodiment, the digital photo system includes a memory or database for storing images, software applications and a processor for logically grouping images and one or more user interfaces. The digital photo system 2 then packages the images together with a software application and/or installer program for delivery to the guest 18. In one embodiment, the images are delivered to the guest 22 via a solid state delivery means, such as CD, DVD, flash memory drive, memory card 26 or other electronic media. The images and access to software may also be delivered via a web-based download. Those of skill in the art will appreciate that the digital photo system 2 may also maintain the images in a form accessible via the Internet or via a specialized intranet by a guest upon entering a particular code or codes. In another embodiment, the one or more images may be printed and delivered to a folder associated with a specific guest. In any of these instances, the guest may be notified that his or her images were ready via an email, text, Twitter®, Facebook®, Flickr®, Instagram®, Picassa, or similar notification, or the guest would log on to an Internet or Intranet site at a later time to access to the digital photo system to obtain their images.

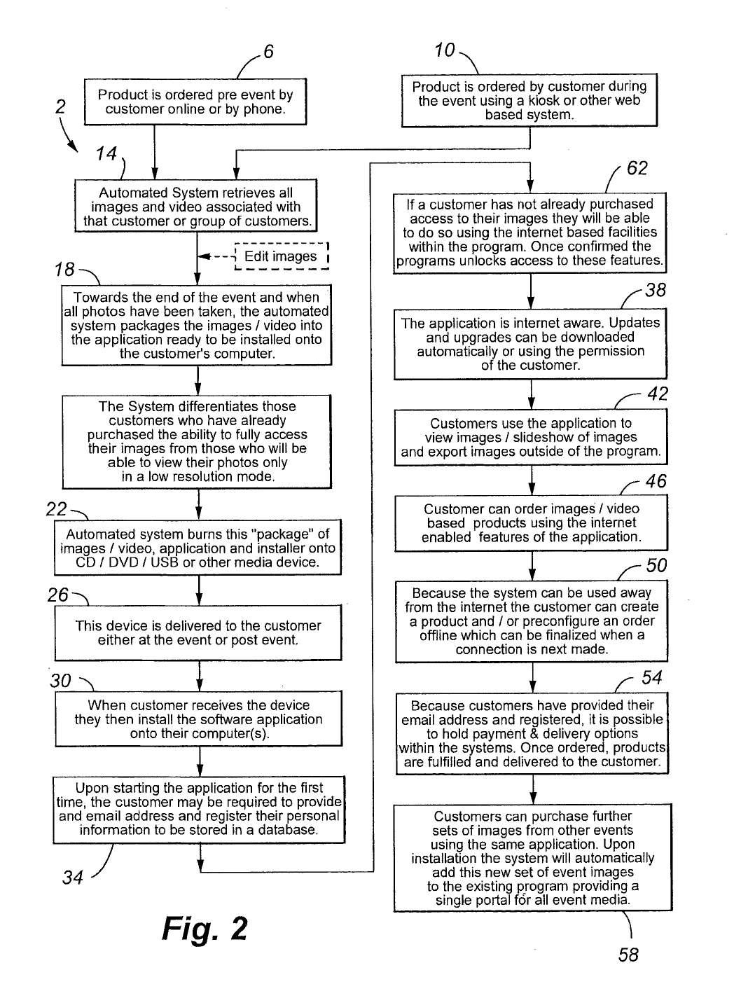

In one embodiment of the present invention, the guest would install the software application received from the event host onto a computer 30 to permit viewing, editing and manipulation of the images. Other embodiments of the present invention allow the user to obtain the application from one or more authorized websites on the Internet or specialized Intranet or by other means. Still other embodiments omit the need for application installation on a personal or home computer. More specifically, an Internet-based system may be provided that accesses the electronic media automatically, or when prompted by the event server. Once accessed, the guest would be able to copy and manipulate the images. The Internet-based system may possess the same functionality as an installed application or may redirect guests to other websites and/or applications that would provide desired functionality. In a related embodiment, a potential guest is given the electronic media that is accessed via an Internet-based application that provides limited access to the images stored on the electronic media (see the description of FIG. 2 below for a discussion of methods of providing pictures to potential guests).

When the application starts for the first time 34, the guest may be required to provide an email address and other information to be used by the application. Other information may include additional identification information as well as delivery and billing information. In one embodiment, the application is Internet aware. When the application is accessed, a connection is automatically made to the Internet to facilitate acquisition and downloading of software updates or upgrades 38. Such upgrades and updates may be downloaded automatically or upon permission of the guest.

In operation, the guests would use the application to view their images individually, via a slide show or any other means currently known 42. If the guest has purchased the images, they may be exported outside the application to the guest's computer, thereby allowing the images to be transferred to other media and computers, via social networking sites, email, etc. In one embodiment, the application links with a social networking site so that the guest does not need to export or otherwise transfer the images to the social networking site. The guest would also be given the ability to order images, videos and related products 46. Related products include, for example, calendars, mugs, clothing, photo books and other items incorporating images. Alternatively, the application may allow for only a limited number of copies to be made of the images, similar to the system employed by Apple's iTunes® music software. Thereafter, additional licenses must be obtained.

In one embodiment, the application will allow for the guest to preview image-based items prior to ordering. In addition, one embodiment of the present invention allows a guest to notify other potentially interested parties that the digital photo system 2 includes images that they may wish to obtain. Once invited, interested parties may access and purchase images or image-based products through a downloaded copy of the application or through a web browser and Internet connection. Those individuals, such as friends, relatives and acquaintances, may also, upon downloading the software, have the ability to interact with the images, download the images, and perhaps upload different images, which enhances the sharing process. Alternatively, after previewing the images in a digital or electronic format, the guest may order one or more images or image related products and have them delivered to the guest's folder in a display area.

The application may also allow for the guest to customize and order image-based products. For example, calendars, coffee mugs, post cards, business cards, paper weights, tee shirts, puzzles, etc. that incorporate an individual image or images. This may be done on-line via the application software, it may be done through a link or other interconnection to a web-based catalog system, or the application may be used in an offline configuration 50. This may be desirable to those who wish to preconfigure an order or create one or more related products offline at their convenience. The order would be automatically finalized when the application is next connected to the Internet or the application would cause the user to be automatically asked or prompted to finalize and submit the order. Finalized orders may be delivered to the guest's folder during an event, with appropriate notification of delivery to the guest, or may be shipped to an alternative location provided by the guest.

Because one or more of guest email addresses, payment information and delivery instructions may be stored in the system, such as at the time of initial registration, product orders may be promptly fulfilled 54. Guests may also access, edit and update their account information. In addition, the software application will allow guests to access and acquire images from other events hosted by the same or related event hosts using the same software. Similarly, images from other events may automatically be sent to an existing guest's account 58.

The event host or operator may also sell advertising and include it in the software application. The advertising may be available as a link to special offers or discounted pricing if the user agrees to view the advertising. It is a potential revenue source for the event host or operator.

FIG. 2 shows a work-flow associated with providing a set of images to a plurality of guests, some of whom have purchased the rights to view, export and use the images, and some who have not. For those who have purchased the rights, the work-flow operates as shown in FIG. 1.

For those who have not purchased rights to the images, the ability to purchase the images post-event is shown. Similar to the embodiment of FIG. 1, the digital photo system 2 provides images or electronic media, or otherwise makes the images available to all participants of the event 26. The potential guest would then install the application onto their home computer, iPad®, iPhone®, lap top, computer or any similar computer or smart phone 30. Guests who have already purchased access to their images would be able to do so using Internet-based facilities within the application. Those individuals who have not purchased images pre-event would be able to do so using Internet-based facilities in combination using the application 62 after an unlock code was entered. The unlock code is provided following completion of guest registration. Alternatively, if the potential guest would prefer to review the images before registering, the images may be altered to allow for a preview for a given amount of time and/or in a lower-resolution format. The altered images may also include a watermark or other means that would render copying undesirable or impossible. Once the potential guest paid for the rights to the images, high quality images would be provided by the application, sent as an email attachment or accessible via an Internet connection, to be copied and manipulated as described above in connection with the embodiment of FIG. 1.

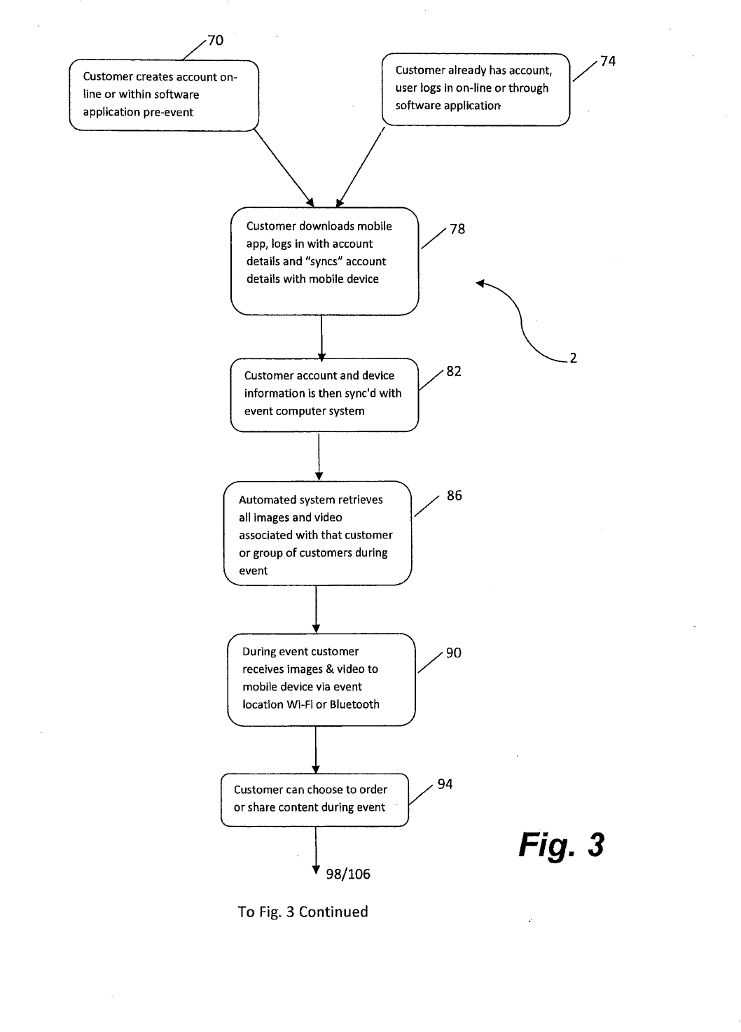

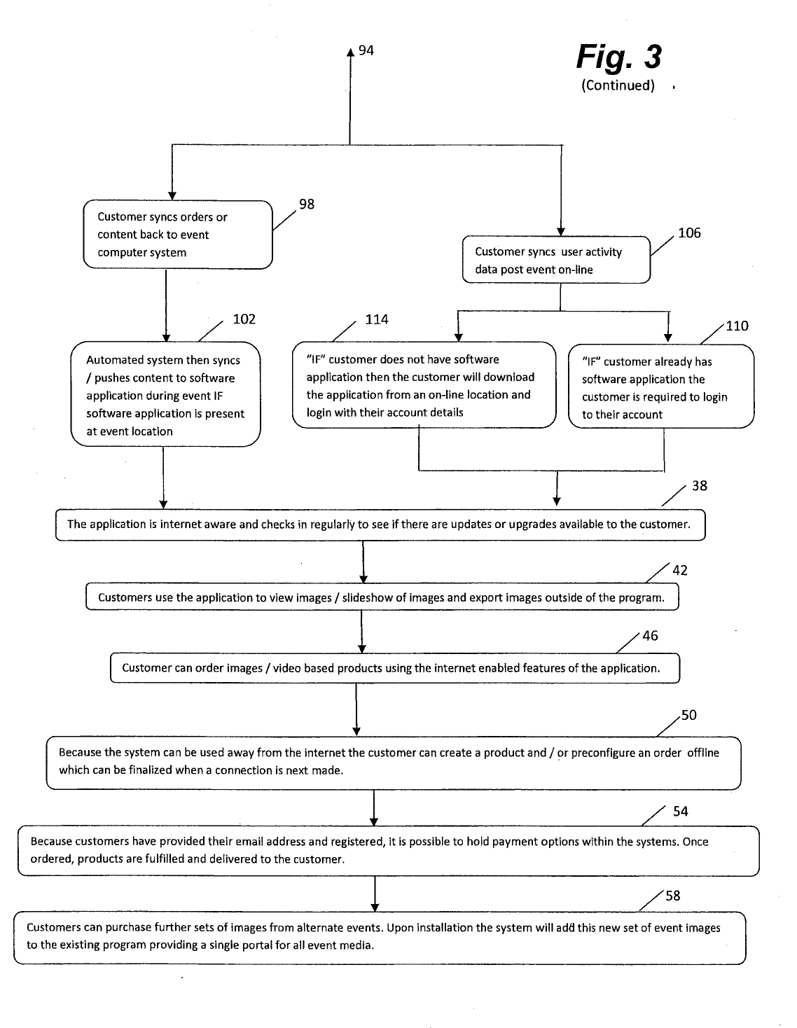

With respect to FIG. 3, still yet another embodiment of the present invention is shown that would be used by a guest via a computer, smart phone, iPad®, or other mobile cellular or web-enabled communication device, to store, view, display, manage and purchase images. This embodiment takes into account the connectivity of the device either via cellular, Wi-Fi or other wireless network technology and allows the guest to receive their images in almost real time and share their images with others during or after the event.

Before or during the event, a guest creates an account online 70 or accesses their existing account 74. The guest may download the necessary software to his/her mobile device or smart phone, such as a Blackberry®, iPhone®, Android® (hereinafter “mobile device”). Applications may be downloaded to more than one device. For example, this may be a mobile device and a laptop computer or it may be two different mobile devices controlled by two different people in a common group such as two parents, two siblings or two friends. The mobile application allows for a guest to log onto their account and sync with personal and event-specific information 78 obtained from the digital photo system 2. The connection between the event server and the mobile device would identify the mobile device and allow for synchronizing 82 of information between the mobile device and the event servers. Such information would include event details, guest pre-purchases and other personal information. The mobile device will receive instructions and settings on how to access the event servers if needed.

At the event, the automated system collects and retrieves all images associated with each guest or group of guests 86. Also at the event, the guest would connect their mobile device to the relevant network that an event operator is using. The mobile device uses the information provided by the operators' event servers to connect to and identify itself to the digital photo system. The event servers may also provide helpful information to the mobile device user such as the location of the photographer/videographer, wait times for access or guidance for obtaining quality images. In this embodiment, however, the receipt of images to an individual's wireless device is generally real-time 90. The images are delivered by any capable wireless communication mode. Alternatively, the images may be sent as an email attachment to an email account associated with the mobile device or other identified devices such as laptops or home computers. Images also may be delivered to the mobile device at a short time later or upon accessing a web-site via the mobile device or home computer, for example. Images may also be printed and delivered to the guest's folder. The guest would thus have the option of purchasing individual images or other products from the mobile device anytime during or after an event or in person at a display area during the event. The guests can also choose to share their event images with others who are attending the event or have been given access online 94. Those sharing with the guest may or may not be given full access to the images or they may be restricted to viewing lower resolution images. The guest would have the option of granting access to their images to someone else's mobile device.

It is contemplated that before the end of the event, the guest may be reminded or prompted to complete the synchronization of their orders. If the guest has orders, those orders may be synched or sent back to the event server if this task is not already done 98. The automated system would then save and process the order and provide the selected images to the user's computer or mobile device if the software application is resident on the computer or device 102. Alternatively, the guest may choose to sync or provide their order online following the conclusion of the event 106. If the guest has an existing account and software application loaded on their computer and/or mobile device, all that is required is for the guest to login access the images and place their order 110. If the guest does not have the software application loaded on their computer or mobile device, the guest will be prompted to download the application software online at the linked site to the system or other appropriate website. The guest will be prompted to login once the software application is downloaded and the guest is appropriately registered 114. The remaining functionality of the application described with respect to FIGS. 1 and 2 may then also be used with respect to the embodiment shown in FIG. 3.

As a further alternative, some embodiments of the present invention may employ a dynamic identification system that uses wireless technology wherein the guest actively notifies an event operator or photographer of their desire to order an image at about the time the image is taken and, perhaps, before the image is taken. This may be accomplished by sending a signal from the user's mobile device to the event server or other wireless receiver that the guest wishes to purchase an image. For example, in one embodiment, a guest would initiate a signal from his/her wireless communication device, such as by way of a previously loaded application, that would notify the event operator or photographer that the image obtained or to be obtained was desired for purchase. The guest could send this signal while waiting in line for the photographer, while posing for the image or following taking of the image. The contemplated signal could be generated by a software application loaded on a wireless communication device or it could be a standard text message sent to a specifically designated text number associated with a particular photographer or location. The signal sent from the mobile device may include one or more of time, location (using GPS, for example) and/or otherwise stamped such that the event operator or photographer could easily link the image to the guest or potential guest. The server could also be linked with the photographer's camera or video equipment to record time, location and other identifying information for purposes of associating images and guests. Alternatively, a display screen or monitor could be located nearby to allow the guest to view the image and then promptly place an order as described. Further still, the software application may generate a custom-specific alpha numeric code, or display a bar code, QR code or any other computer readable code, on the screen of the mobile device which is scanned by the photographer and associated with the image or images taken by the photographer. The user-specific images may then be sent directly to the user's mobile device or any other device identified by the user and maintained in the server database. Alternatively, the images may be placed in the guest's folders perhaps along with other images and/or image related products the event holder believes the guest may be willing to purchase. In one embodiment, the technology is similar to QR codes used by merchants to provide access information about their products. It is contemplated that the guest would have the ability to verify that an image was the image that they desired for purchase. Still other embodiments of the present invention allow for the guest to expand the time window to allow them to view other images around the time that they requested their image. If required, the guest may be instructed by the program to connect to a particular network or use a particular wireless technology when at the event to allow for connection to the event servers.

In another embodiment of the present invention, a guest employs their mobile device similar to that described in FIG. 3 to capture images of which they may or may not be the subject. More specifically, the application of one embodiment includes functionality that allows individuals to indicate to an event server that they are interested in purchasing images associated with specific time and/or location. During a sporting event, for example, it may be desirable to possess a high quality professional image of a certain sub-event of the main event. As such, freelance photographers, or photographers employed by the event operators, may submit their photos to a generalized event server. When a particular sub-event occurs, whether anticipated such as a record breaking homerun or unanticipated such as a game-winning score, the interested guest may access the application via their mobile device and indicate that an image of that sub-event is desired. The system would then identify the mobile guest, identify the time and/or location stamp associated with the sub-event and match that information with images submitted by one or more photographers in the event system. Those images would then be transmitted to the guest for review. It is contemplated that the application may provide to the guest images for a specified time frame before and after the actual sub-event such as plus or minus 5, 10, 15 minutes, etc. from when they indicated their interest in the image. This would allow the user to view a narrow sub-set of images as opposed to viewing all the photos associated with the event. Alternatively, an individual may request all of those photos submitted in an event for review and purchase.

The methods described herein can be a set of computer-executable instructions executed by a computer system or processor and/or encoded or stored on a computer readable medium. Computer-readable medium refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible, non-transitory storage medium and prior art-recognized equivalents and successor media, in which the software implementations of the present invention are stored.

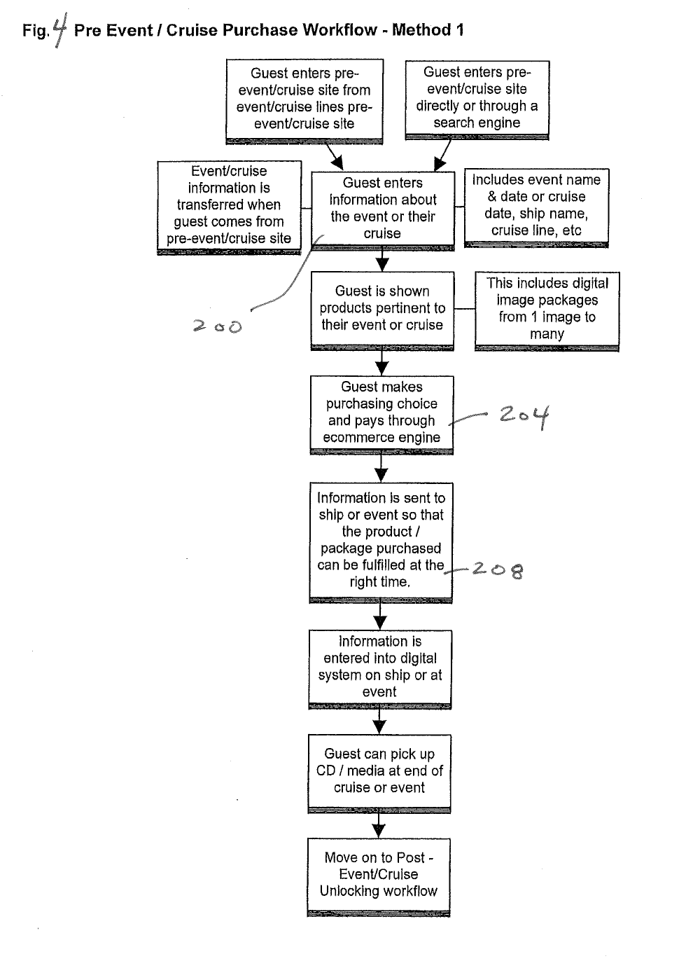

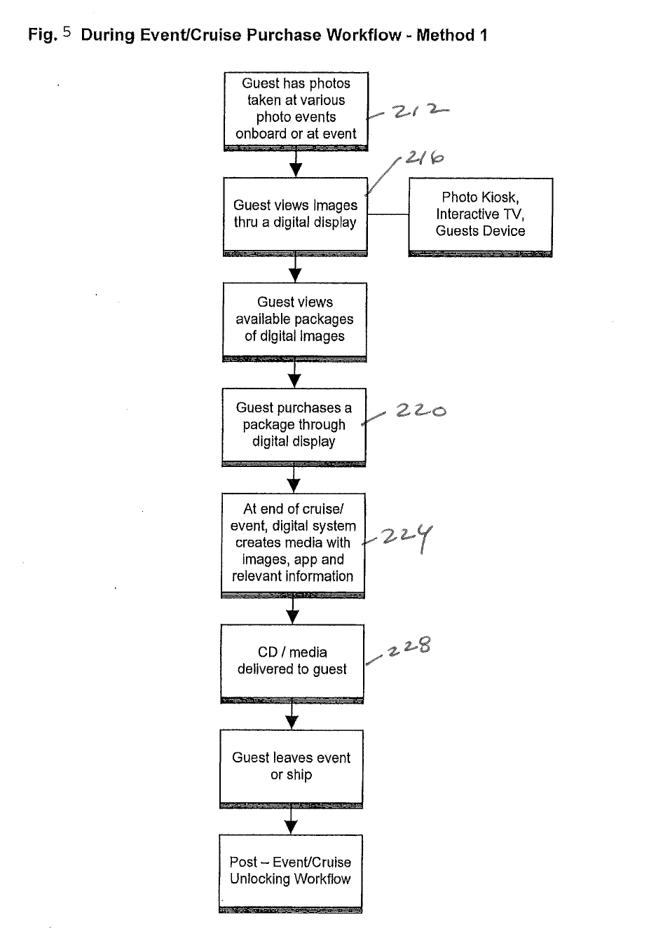

FIG. 4 illustrates a cruise purchase workflow of one embodiment of the present invention wherein guests can purchase a digital image package via a web site before the cruise begins. Although the following discussion is concerned primarily with the cruise industry, those of skill in the art will appreciate that the systems and methods described herein can be applied to other event types without departing from the scope of the invention. In this example, the guest can use a website to provide information 200 about their upcoming cruise that will be used later to customize their image applications or to help the photo system link them to their photos. Alternatively, the information can be transferred from a referring website, such as a cruise line's on-line check in or pre-cruise planning web portal. The event or cruise-specific information may be important because different image packages or, prices, or products may be event, ship, or cruise date specific. The guest chooses which package they would like to purchase from the available options 204. A package could have as few as one photo or many photos depending on the length of cruise, cruise destinations, price, demographic available, and geographic location of the ship. The transaction occurs through an ecommerce engine and the relevant information about the guest, cruise details, product purchased, etc. is transferred to the cruise ship 208, preferably before departure so that the product can be fulfilled when the guest is onboard.

FIG. 5 shows a cruise purchase workflow that commonly occurs during the cruise wherein the taking, editing, and storing of images occurs 212. Known guest-to-photo recognition techniques and those described herein are used to link or index the photo to the guests so they can later be retrieved. The guest uses a photo kiosk or other electronic display to view their images 216. In one embodiment, the guest finds their photos by swiping their cruise card (that contains a unique identifier) on a card reader that instructs the kiosk the digital system to retrieve their photos from a database. Of course, traditional photo display methods can also be employed wherein the guest would find and retrieve their photos from a display area and provide them to a staff member to link them with a guest-specific electronic profile. If the guest did not purchase a pre-cruise package, they can choose to purchase various products including digital images. Rather than being given one option for purchasing all guest photos, a number of different packages are offered to the guest similar to the pre-cruise method of purchasing described above with reference to FIG. 4. When the guest selects a package 220 and the kiosk takes payment or instructs how to make payment with a cruise line specified terminal that is manned by a staff member.

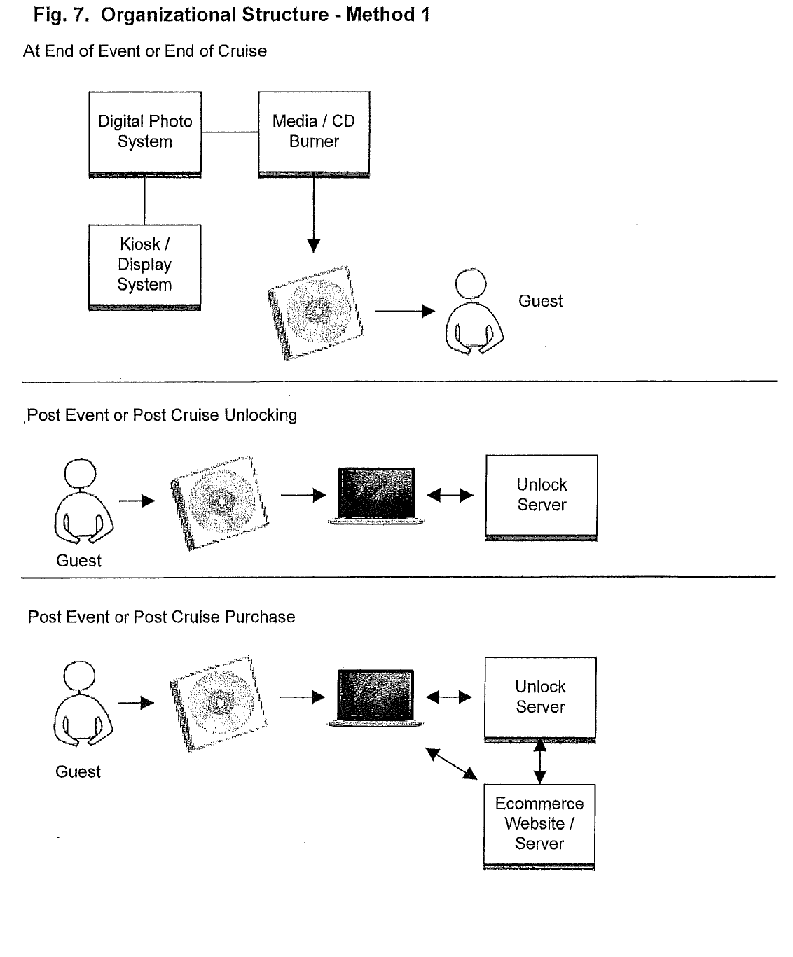

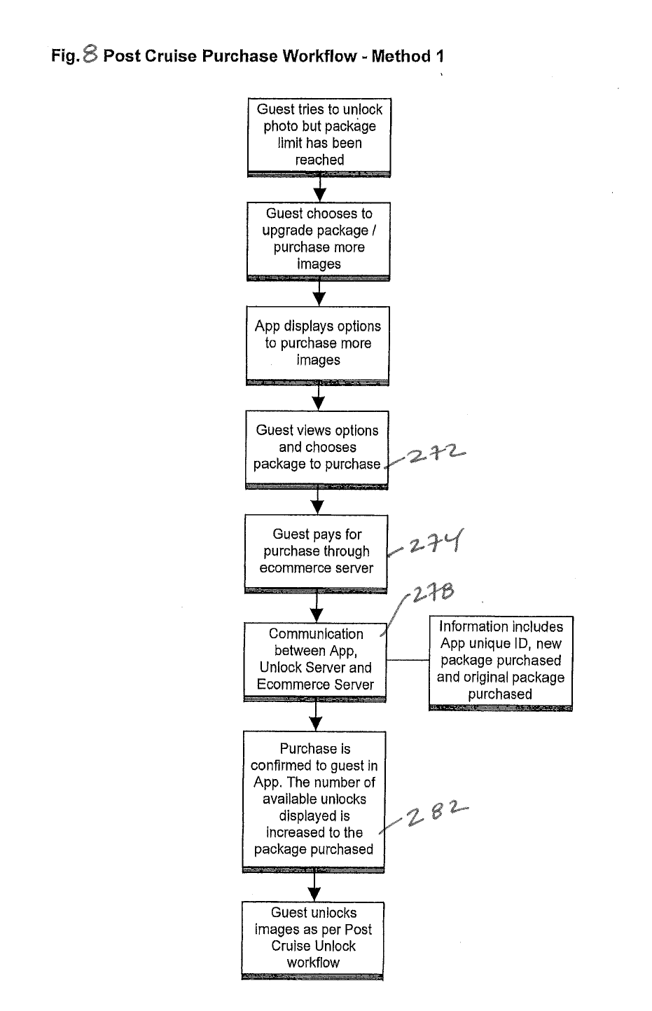

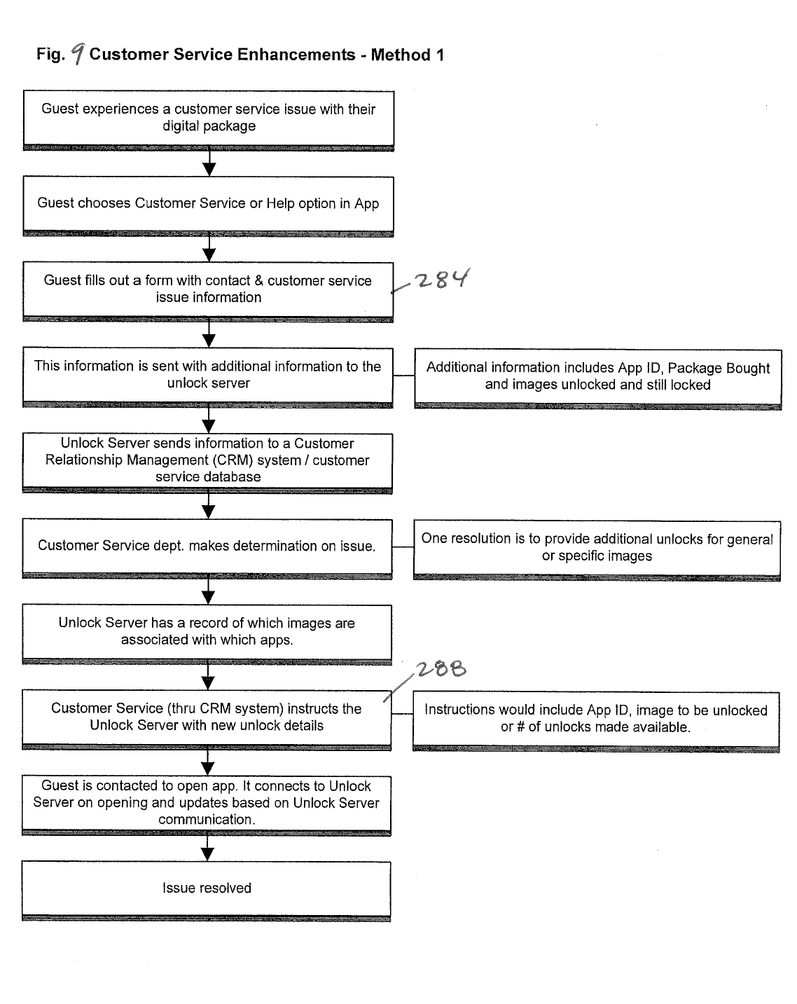

When all of the events have occurred typically towards the end of the event or cruise, the images are uploaded to a computer-accessible media such as a CD 224. (See FIG. 7.) More specifically, the digital photo system combines the information about what package the guest has purchased, a viewing and selection application, the guest's photos, and an installation program onto computer-readable media such as a CD or a memory storage device that is given to the guest before they leave the ship 228.

An alternate method is that the guest is given a memory device, like a USB accessible memory stick that they can interconnect into the kiosk to download the different elements required viewing and selection (application software, locked and encrypted photos, installation software) at the end of the event or cruise or immediately after they have purchased the package. The USB accessible memory device may already have the application and installation software installed wherein the guest simply uses the USB accessible memory device to interconnected to the kiosk to download locked and encrypted images. The memory device can then be periodically uploaded with cruise photos from the kiosk. In another embodiment, images as they are taken, or shortly thereafter, they are sent locked and encrypted with a thumbnail version for previewing to a guest's mobile electronic device. In this example, the guest would have installed a viewing application or access a wed-based application before the locked images could be reviewed, which will be described in further detail below.

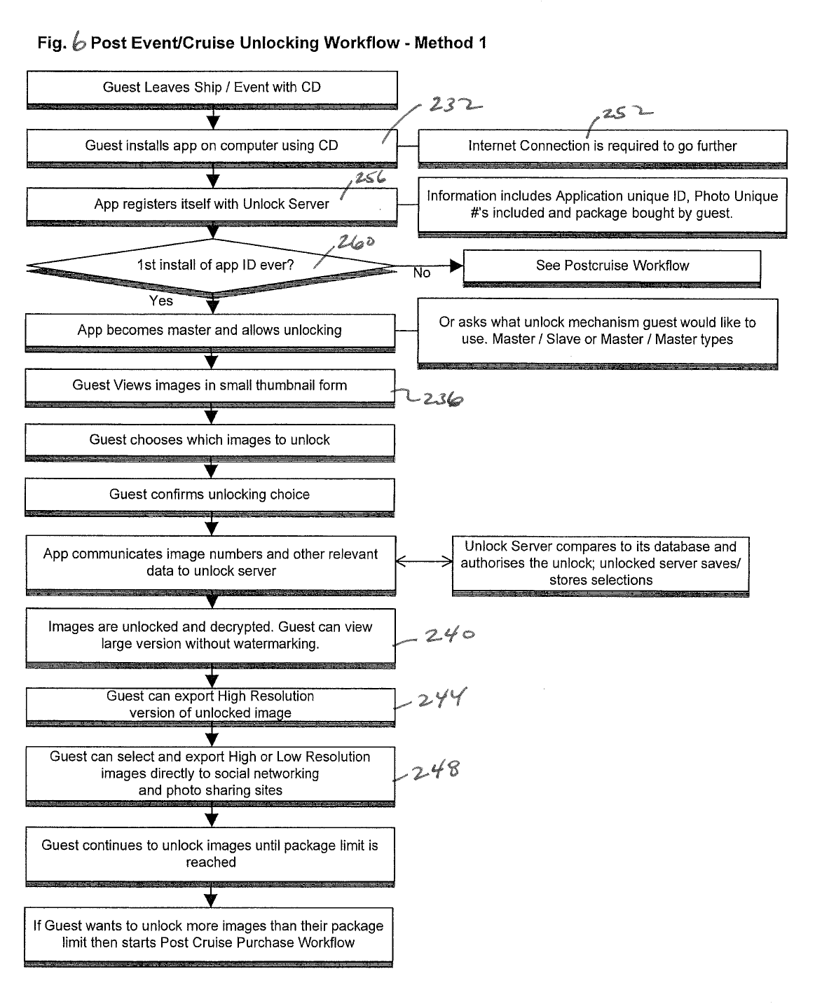

FIGS. 6 and 7 show a post cruise photo viewing and unlocking workflow wherein the guest installs 232 the application onto their computer or mobile computing device via a downloaded app, for example. The application contains all of their digital images in an encrypted and locked form, smaller thumbnail images, and a viewing and selection program. The application is aware of which package the guest has purchased and displays this to the guest. Alternatively, the guest inputs a code that tells the application which package was purchased. The guest views 236 copy protected thumbnail versions or watermarked versions of their images and selects photos they wish to unlock. Unlocked images are decrypted 240, and exported in a high-resolution version to their computer where they can be viewed, shared, or distributed. That is, once the images are unlocked, the application allows the guest to export images individually or in groups to social media and other photo sharing web sites 248. As the guest unlocks photos the application makes the guest aware of how many remain available to unlock from the purchased package. One embodiment allows the guest to expand their package upon payment.

It is important to know which images the guest has decided to unlock so that the system can ensure that only the pre-approved number of images are delivered to the guest. More specifically, it is desirable to reduce the possibility of circumventing the system to unlock more than the predetermined amount of photos. Media like CD's and memory drives can be shared between multiple computers and applications can also be installed multiple times on the same computer. In these cases it is possible to install the application and photos on a computer and unlock the available number of photos allowed by the package and then install the application again and unlock a different set of images. The net result of this activity is that it is possible to unlock all of the images, even if a size limited package has been purchased.

To address this issue the application requires an internet connection before unlocking can commence 252. When the guest makes their choice of which images to unlock the application transfers the relevant information to an Unlock Server 256 that records this information and authorizes a particular image to be unlocked. The relevant information could include a unique photo number, a unique CD number, a unique application number, a unique guest number, and the type of package originally purchased. Future versions of the application check with the Unlock Server to assess whether the CD/application has registered itself before 260 and, if so, which photos have been unlocked. Further, in one embodiment, each instance of the application periodically checks with the Unlock Server to ensure that it is showing the correct locked/unlocked images.

One embodiment of the invention also controls which instance of the application permits unlocking the images. For example, the first, master instance of the installed application is the only copy that is allowed to unlock images. Additional versions of the application would be slaves that only have the ability to view all of the images in thumbnail or watermarked form and to export only those images that have already been unlocked by the master copy. As the application contacts the Unlock Server at regular intervals and specific times (for example, when the application is opened) the slave copies will see the latest unlocks as created by the master application.

In an alternate embodiment, all copies of the application are master copies. This means that any of the application installations can unlock and export images as long as they do not exceed the total number of unlocks as defined by the purchased package. Whenever the program is started, a photo is unlocked, or periodically thereafter the program will check that it has the correct images denoted as locked or unlocked and the correct number of images left to be unlocked from the purchased package are displayed. Another option for choosing the unlocking mechanism is to allow the guest to choose whether they want the master/slave or master/master type when they first start the application. In the first instance when the application is installed on a computer and communicates with the Unlock Server, it will inform the user whether they have permission to unlock the event or cruise images.

Other embodiments control access to locked or unlocked digital images by requiring a guest-specific login or software application identifier. This system allows multiple logins with the same CD but also allows control of unlocking by allowing one master account associated with the application to manage permissions, etc.

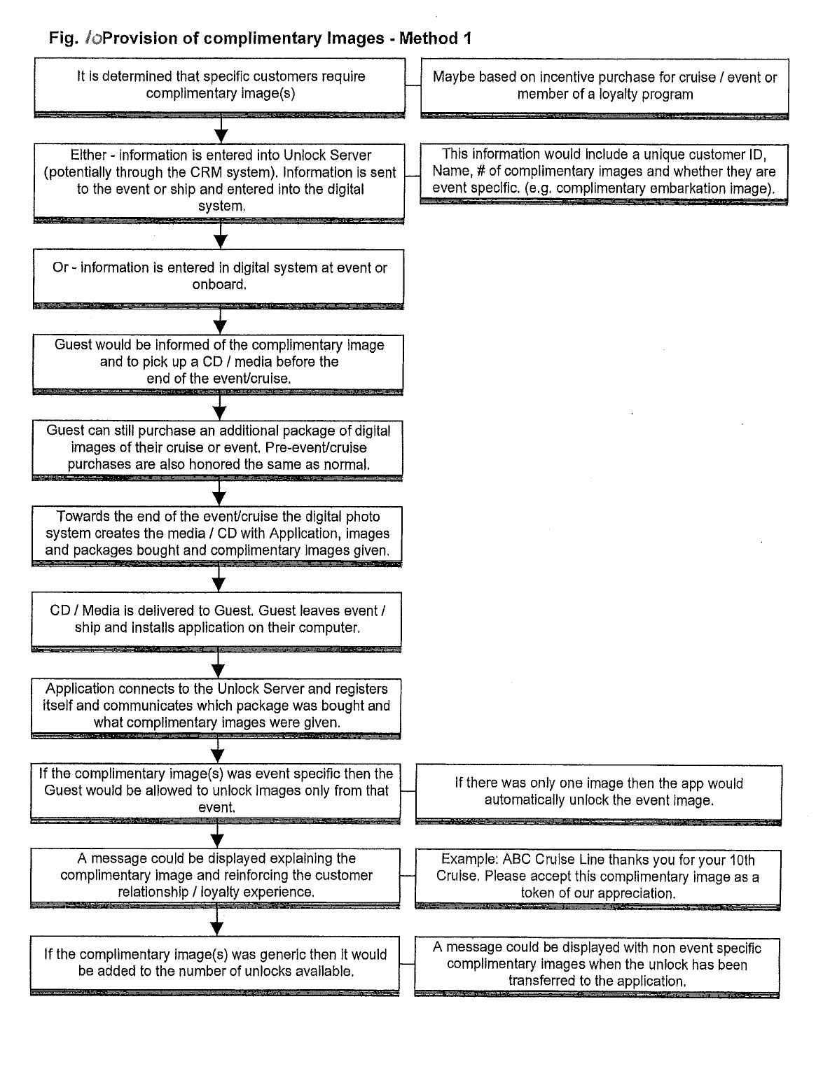

FIG. 8 shows a post cruise purchase work flow that allows a guest to upgrade a previously-purchased package or purchase a new package when the guest has unlocked the predetermined number of images as defined by the purchased package. Payment to expand a package is made through the program's interface using an internet connection using known payment methods. For example, the application will allow guests to purchase additional photos 272 from within the application that has a link to a web-based ecommerce 274 engine, such as PayPal®. The application may also accept a credit card payment. The application and/or the ecommerce server will communicate with the Unlock Server 278 to notify it that the guest associated with the CD or application has made the purchase. Immediately, or the next time the guest's application makes a connection to the Unlock Server the new image credit details are transmitted to the application and the number of image unlocks available are revised 282. The post-cruise is also available to slave copies of the application if they decided they wanted to purchase the ability to unlock locked images. An example of this would be when a guest shares their photos with one of their relatives. The relative could export any unlocked photos which the guest had already unlocked, but could also purchase additional photos if they wish.

The application of some embodiments will also allow guests to create other photo products from both the locked and unlocked images including prints, photo books, and other creative photo products such as calendars, mugs, snow globes, etc. The guest would be able to choose which photos they include in these products, and when their customization of the product was complete would purchase the products using a similar mechanism described above for post-cruise purchase of digital images. The guest or third party would also able to upload their own images to be included in these product options.

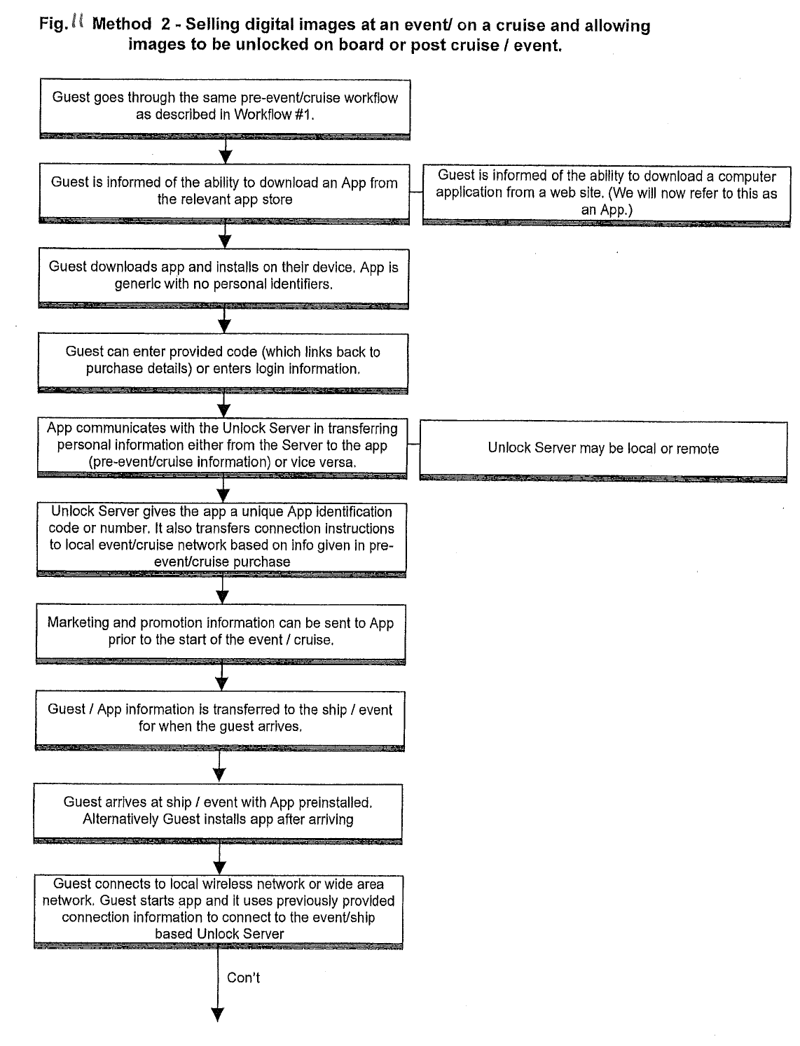

FIG. 9 illustrates guest enhancements associated with one embodiment of the present invention that allows for improved guest service and guest interaction. For example, the application of one embodiment includes a built-in customer service form 284 to address issues. The form would require contact details, if needed, as well as a description of the problem and would automatically be populated with any extraneous data such as an application unique number, user number, which photos have been unlocked, the package originally purchased, and any subsequent purchases. The Guest Service department would be able to credit additional unlocked photos 288 to a specific application as a way to resolve the guest service issue.

Another embodiment allows the guest to change which computer was the master application by un-authorizing the current master. Here, a menu command would be provided that would instruct the application to become a slave version and would allow another instance of the application to take over the master role. If the guest was unable to enact the menu command themselves then the guest service group could deauthorize the master capability of a certain application serial number which would allow another copy to become the master version. This would be useful if the computer with the master application was lost, stolen, or replaced.

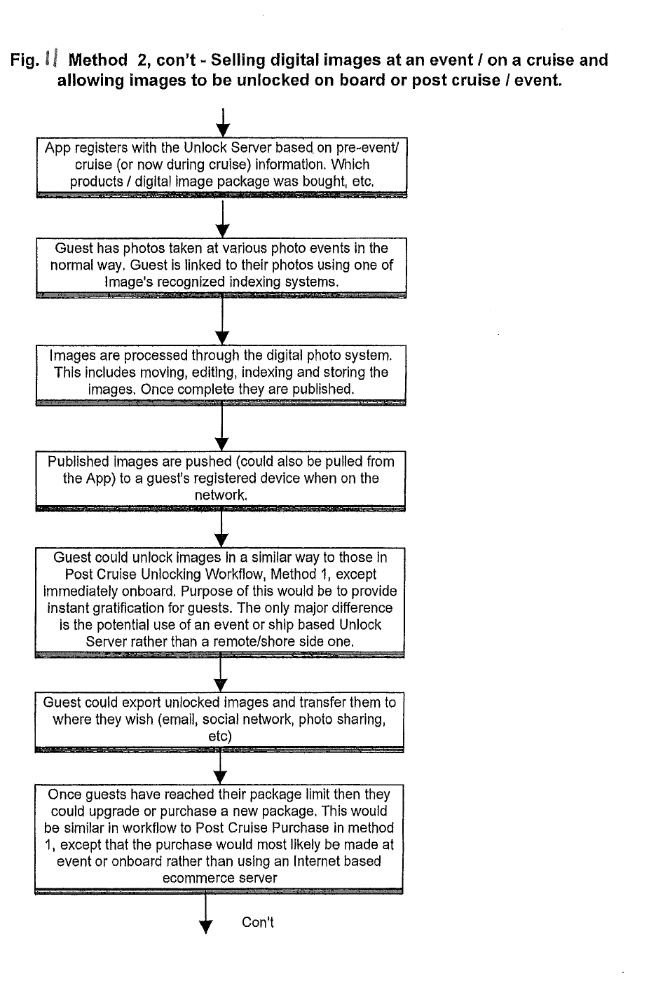

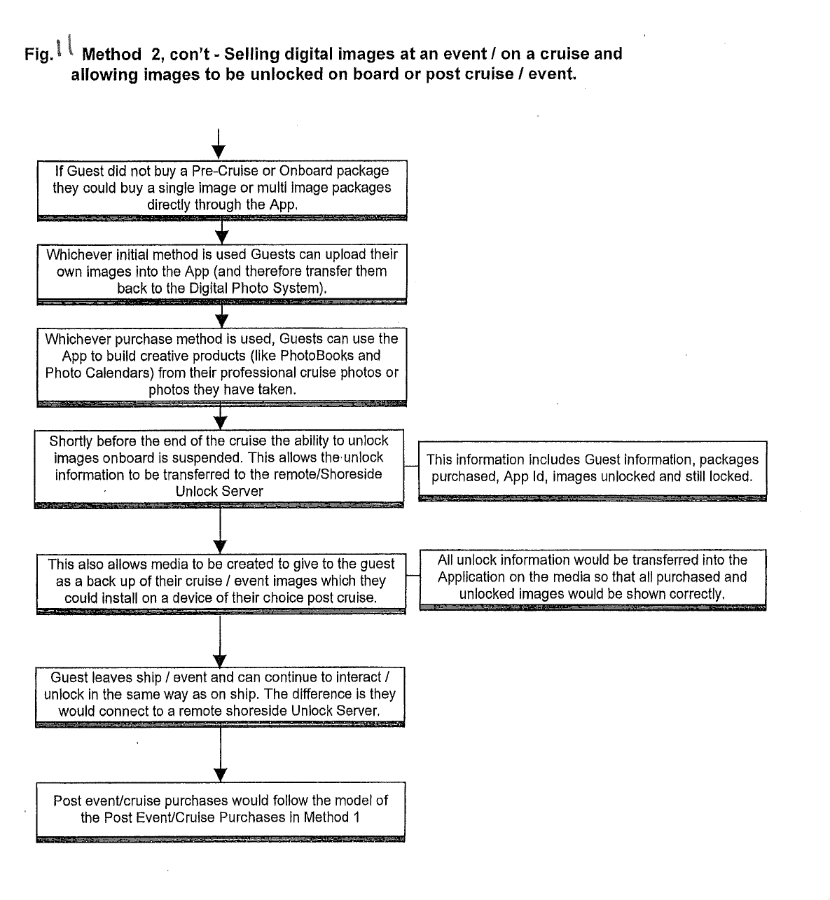

Referring now to FIG. 10, a method of providing complementary images is shown. If the operating company wanted to provide complimentary photos to specific guests based on their previous purchases, membership in a loyalty program, or for some other reason, such functionality could be provided through the Unlock Server. Such complimentary photos comprise photos of the ship, the ports of call, or photos specific to a certain event. Photos could be preselected by the cruise operator and be preprinted on cards with unique identifiers. The cards would be associated with various sizes of packages. The operator, maitre d', activities coordinator, etc. could give the card to the guest who thereafter would enter the code into the application which is transmitted to the Unlock Server. The Unlock Server would recognize the code and notify the application to increase the number of unlocks by a predetermined amount. In the same manner, the cruise operator could also provide photo credits to guests as gifts, attendance prizes, bingo prizes, booking incentives etc. Further, the application and Unlock Server structure could be set up so that it would be possible to define specific events which could be provided on a complimentary basis limiting the type of photos which could be unlocked using this system.

This new and refined method for selling limited quantities of digital photos has a number of advantages when compared to a sale of all photos model. For example, by offering a lower price point for less volume the market of selling digital images is broadened. Further, the sales approaches described herein ensures that purchases are made pre-cruise or during the cruise, so it encourages the impulse purchasing. The ability for the guest to take their photos with them directly from the ship also provides instant gratification, but the guest can choose a convenient photo selection time.

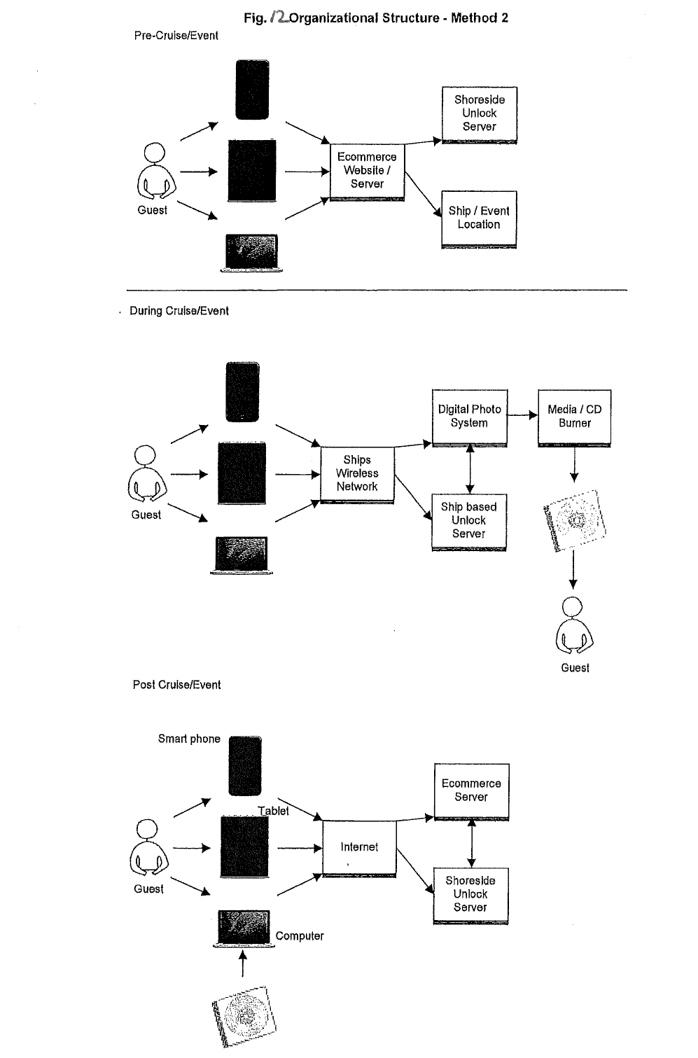

FIGS. 11 and 12 show yet another embodiment of the invention wherein digital images sold on a cruise and photos are allowed to be unlocked while onboard the ship. More and more people have computer devices that are portable, such as smart phones, lap top computers, or tablets. These portable devices are now being brought on cruises in unprecedented numbers and are an untapped opportunity for interaction with digital photo systems. This method uses a similar set of technologies to the methods described above and is split into two workflows. The first is directed to smart phone and tablet devices that traditionally use an installed application (i.e., “app”) purchased from a dedicated app store, another method is directed to laptops running an open operating system and using an application installed from computer readable media like a CD.

In these examples, a guest purchases a digital images package pre-cruise as described above. After purchasing the guest is notified that the app is ready to download from the relevant “app store”, dedicated download site, or the guest is provided a web link to the app. When the app is downloaded to the device it is a generic having no personalization and the guest must create an account, access an existing account, or use a code to connect to the Unlock Server described above. The app communicates with the Unlock Server, which has the guest's details from the pre-cruise purchase. Further, communication between the app and the Unlock Server may create a unique app reference or ID number. As one of skill in the art will appreciate, accessing photos using the app is different than a photo kiosk that requires that the guest swipe their cruise card, credit card, or other means of identification to view their photos. More specifically, in one embodiment, all of the app information, personal information, and pre-purchase products information are forwarded to the ship before the cruise so that when the guest arrives for their cruise the digital photo system will be ready to include the device and app in its service. Alternatively, the app could be downloaded while on board where the guest uses their name and cabin number and a cruise staff member verifies the guest's information, etc. Further, as briefly mentioned above, the app may allow real-time or near real-time communication between the mobile device and the image storage location, i.e., a photo kiosk or an event server, to allow guest-specific photos to be automatically uploaded, perhaps in a locked and encrypted form, to the device.

Alternatively a guest can download the generic app from an app store and use the app to purchase a package. The app would record a similar set of information as that in pre cruise web site purchase and would forward these to the Unlock Server and/or ship as needed to fulfill the guest's order. Before the cruise a variety of marketing material, special offers, and information can be shared with the guest using the app as it is likely to be connected to the Internet on a regular basis

When embarked the guest will have access to a Wi-Fi network (the on ship Wi-Fi networks are traditionally free with charges made to access the internet). Using instructions and settings originally created in the app or downloaded later when connected to the Unlock Server, the app will attempt to automatically log into the digital photo system Unlock Server located on the ship. When the app connects to this server it communicates its unique code which is known from the information provided to the ship based Unlock Server from the shore side Unlock Server and pre cruise web site system.

Alternatively, the guest will be able to download the app pre-cruise without making a purchase. They would be free to register their app before the cruise so that their personal details are entered before the cruise and the device would connect automatically to the digital photo system. Alternatively, the guest could start up the app after they embark the ship and be taken through a number of questions in the app to provide the required information to link them to the digital photo system. This information might include, name, cabin number, guest reference number, or unique booking ID number. If the guest has not purchased a digital photo package pre cruise they could purchase one using their device which would show the purchase options available or purchase photos individually. Alternatively they could purchase a package at a photo kiosk and the app would be credited with the correct number of unlocks. The functionality of the contemplated app could be embedded in a ship, event, or amusement park app.

As photos are taken of the guest (including person's in the guest's family, friends, entourage, etc), they are edited and published using a digital photo system. Publishing a photo consists of taking individual photos through a variety of internal quality control and indexing processes such that it is ready to be viewed by the guest. Once a guest's photo is published it is pushed to the guests device onboard (or pulled from the digital photo system to the device) and can be viewed. The guest views thumbnail images or low resolution photos that are watermarked for copy protection. Alternatively, if storage space on the mobile device or data transfer bandwidth of the ship is limited, guests are given access to a cloud where they can review their digital images. Again, to conserve bandwidth, the review versions can be low-resolution such that the guest can review a high resolution version at a centralized photo display area (i.e., accessed on a computer, tablet, etc. by a staff member), at a kiosk, or on their room television. Once photos have been viewed the guest can make an unlocking decision as also described above. The guest would choose an image (or images) and press the unlock button on the device. The device would authorize the unlocking by registering the application serial number and the photo(s) to be unlocked by a ship-based unlock server or central event unlock server. In one embodiment, the guest would view the unlocked photos in a separate section of the screen and would be able to export them using email, file transfer, or a link to a social media or photo sharing web site. The app would indicate the number of images left to be unlocked from the purchased package.

The guest will be able to upgrade to a higher level package in the same way as described above. If the guest had exhausted all of their unlock credits the program would notify them of the additional options and the guest would make a purchasing decision through their own device. The purchasing transaction would occur through the app and be posted to the cruise lines Point of Sale (POS) system or alternatively a regular ecommerce engine would take payment using a credit/debit card.

The guest will be able to take their unlocked and locked photos and make additional custom products like photo books, photo calendars, etc. They can also use the app to order photo prints and customize images including by adding templates for later printing. The guest will also be able to upload images from their device into the app which will transfer these images into the digital photo system so that those photos can be used in customized products like photo books, etc. This functionality of the app also allows the guest to share images with others logged into their account or to a linked account.

Shortly before the end of the cruise the unlock server will be turned off or suspended and guests will not be able to unlock any more of their photos on board. This is so that the information related to what transactions the guests have performed (products & packages purchased as well as which photos were unlocked) can be transmitted to a shore-based Unlock Server. When a centralized Unlock Server or cloud network is used, then this step may not be required. Suspending a ship based Unlock Server also allows the digital photo system to produce the CD's for the guest to take home with them to ensure they have alternate source for their digital images. When the CD's are created, information is included to notify the application which photos have already been unlocked by the guest. This means that subsequently when the application is installed on the guest's computer (rather than tablet or smartphone) it automatically unlocks those photos already unlocked by the guest during the event or cruise. This ensures there is consistency through the different devices the guest will potentially use.

Once the guest disembarks the ship and is able to use the internet, the device will function similarly to how it did onboard, except that it will now be communicating with the shore-side Unlock Server and the pre cruise/post cruise ecommerce purchase system. Guests can unlock images from their existing package and can purchase additional packages of unlock credits.

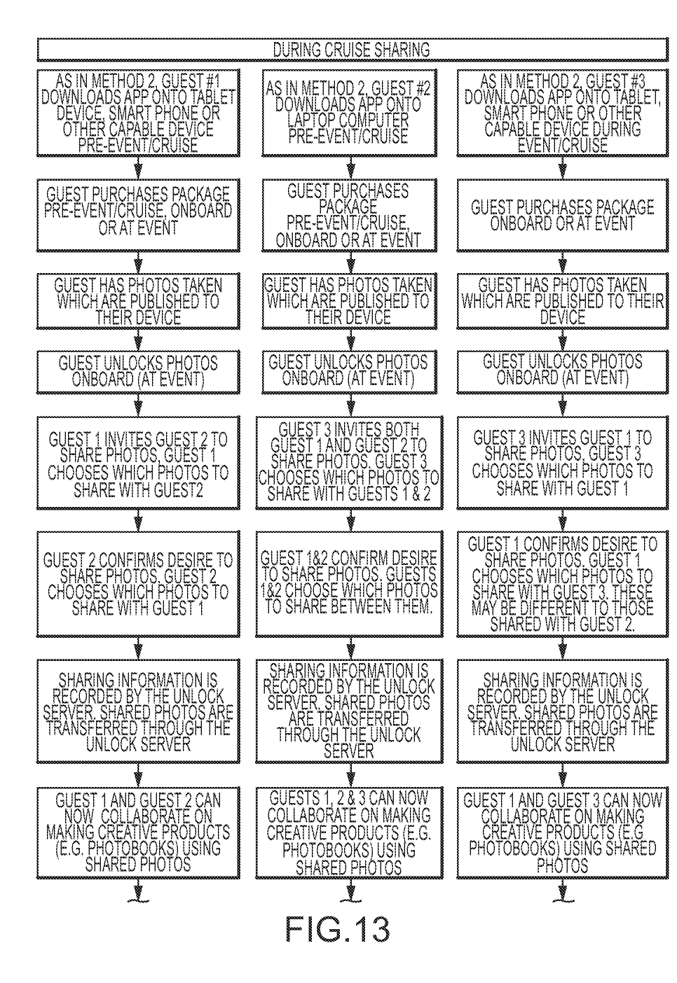

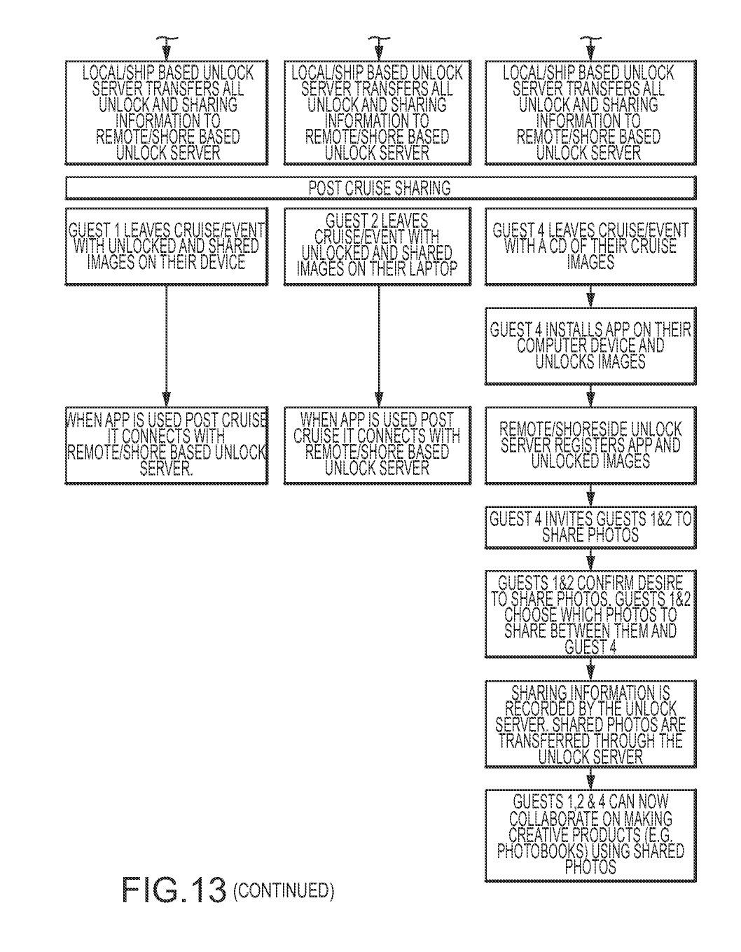

FIG. 13 illustrates the photo sharing capabilities of one embodiment of the invention. The previous methods discussed the ability to purchase, choose and unlock images in an event photography environment using a client application and a server. Taking this solution one step further, the system may permit an extended solution to allow guests to share purchased/unlocked images in among a family or friends group.

As an example, an extended and multigenerational family is travelling on a cruise ship in four different cabins—grandparents in one cabin, their daughter and husband in another, their kids in another, and the grandparents son and his girlfriend in the last. In this situation it is possible that each party might purchase their own package of photos. The photos linked to them might include others from the overall family group if guests were specifically tagged in the images using one of known or disclosed indexing methods. However it is possible that many of the photos of the grandparents would be unique to them and many of their son unique to him based on the fact that they are in different cabins and using different cards to link them to their photos when they were being swiped or connected when the photo is taken. Commonly, cruise ship photo providers often only allow linking by cabin of photos that include a minor child. That is, parents of the child can purchase photos showing their children regardless of whose cabin card was used when the photo was taken. This linking concept has been expanded by embodiments of the instant application.

More specifically, the family may want to share photos between them and they may also want to collaborate in the creation of joint creative products like a family photo book. The client applications described above provide masters and slaves applications where the masters can make unlocking decisions. When the guest makes the purchase either pre-cruise or during the cruise the system has access to guest-specific information including their cabin number, name, and other pertinent details. If a guest wanted to share their unlocked images with another party it would be possible for them to invite the guest to share photos by going through the Unlock Server or by a direct peer-to-peer type arrangement. Embodiments also allow multiple guests to link cabin-specific photos or individual guest photo accounts or applications so that their photo packages can be shared easily. In the case of using the Unlock Server the server could handle the requests and hold these until the recipients application next connected. It could also handle the transfer of photos that have agreed to be shared. The Unlock Server could also be the repository for the shared creative product like the family photo book so that each party could work on it when they were connected at different times.

This process could occur on the ship, using the shipboard Unlock Server, or post cruise using a shore side Unlock Server. Purchasing a creative product would occur as described in the methods described above. On the ship the transaction might occur using the cruise lines POS and post cruise using a regular ecommerce engine on the Internet.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A method for providing images to an event guest, comprising:
obtaining an image order from the event guest before an event;
obtaining a plurality of images of the event guest at the event;
saving said plurality of images on a computer-readable medium;
accessing said computer-readable medium after the event;
selecting a subset of images from said plurality of images; and
obtaining copies of said subset to fulfill at least a portion of said image order.

2. The method of claim 1, further comprising selecting a second subset of images from said plurality of images to obtain copies thereof, said second subset comprised of at least a portion of said image order, and the images of said subset and said second subset comprising a number of images that does not exceed the number of images in said image order.

3. The method of claim 1, wherein said computer-readable medium is at least one of said compact disc, a thumb drive, and a memory card.

4. The method of claim 1, wherein said computer-readable medium is access to an internet-based database.

5. The method of claim 1, wherein said computer-readable medium is access to a database via an application on a mobile computing device.

6. The method of claim 5, wherein said digital images are forwarded to said mobile computing device shortly after the image is obtained.

7. The method of claim 1, wherein said image order, which comprises a number of digital images, can be expanded pre-event, during said event, or after said event.

8. The method of claim 1, wherein said guest is provided visual access to said plurality of images, but can only unlock and save a portion of said plurality of images based on said image order.

9. The method of claim 1, wherein said computer-readable medium includes an application that communicates with a server that stores information associated with the event guest, the event guest's image order, and number of images selected and copied by the event guest.

10. The method of claim 9, wherein said plurality of images are encrypted and unlocked by said server upon event guest request so long as the event guest has not exceeded the number of images associated with said image order.

11. The method of claim 10, wherein said application is used to make a first computer a master computer and a second computer a slave computer, said master computer having the capability of reviewing said plurality of images and to unlock said plurality of images, and said slave computer having the ability of reviewing said plurality of images but saving only those images that have been unlocked by said master computer.

12. The method of claim 9, wherein said application allows the event guest to add personal photos to said plurality of images.

13. The method of claim 9, wherein said personal photos are saved on a centralized server.

14. The method of claim 1, further comprising linking said plurality images with the event guest.

15. The method of claim 14, wherein said linking is achieved by facial recognition.

16. The method of claim 14, wherein the event guest is given a code that is used to link them to said plurality of images.

17. The method of claim 14, wherein the event holder is linked to said plurality of images by accessing a code from a wireless device and conveying said code to an event holder after each image of said plurality of images are obtained.

18. A method for providing images to an event guest, comprising:
obtaining an image order from the event guest before an event;
obtaining a plurality of images of the event guest at the event;
copy protecting said plurality of images;
saving said copy protected images on a computer-readable medium;
delivering said computer-readable medium to the event guest;
providing an application program to the event guest; and
communicating with said application program to selectively allow the event guests to obtain copies of at least one of said plurality of images.

19. The method of claim 18, wherein said copy protecting comprises including locked versions of said plurality of images that are selectively unlocked by said application only after communication with a centralized server.

20. The method of claim 1, further comprising expanding said image order upon payment by the event guest.
